(19) United States
(12) Patent Application Publication
(10) Pub. No.: US 2014/0346377 A1
(43) Pub. Date: Nov. 27, 2014

(54) RADIATION THERMOMETER

(71) Applicant: Land Instruments International Limited, Leicester, Leicestershire (GB)

(72) Inventors: Jonathan Raffe Willmott, Leicester (GB); Susan Fiona Turner, Leicester (GB); Malcolm Ian Gillott, Leicester (GB)

(73) Assignee: Land Instruments International Limited, Leicester, Leicestershire (GB)

(21) Appl. No.: 14/365,510

(22) PCT Filed: Nov. 29, 2012
(86) PCT No.: PCT/GB2012/052937

§ 371 Date: Jun. 13, 2014

(30) Foreign Application Priority Data
Dec. 16, 2011 (GB) 1121657.9
May 17, 2012 (GB) 1208677.3

(51) Int. Cl. G01J 5/08

(52) U.S. Cl. CPC G01J 5/0806; G01J 5/0896; G01J 2005/0077
USPC 250/578.1

(57) ABSTRACT

A radiation thermometer is provided, comprising: a thermal radiation detector assembly having an operative surface area responsive to thermal radiation of a first wavelength; a focussing optics assembly adapted to focus both thermal radiation of the first wavelength and visible light of a second wavelength along an optical axis, the focussing optics assembly being configured to form a focussed image of the operative surface area of the thermal radiation detector assembly on a focal plane outside the radiation thermometer, the focussed image of the operative surface area defining a target region from which the thermal radiation detector assembly detects thermal radiation; a visible light source assembly adapted to exhibit an illuminated pattern of visible light of the second wavelength, the visible light source assembly comprising at least one visible light source and a mask through which light from the at least one visible light source is arranged to pass, the mask having one or more substantially opaque portions and one or more translucent portions arranged to define the illuminated pattern; and a radiation splitter adapted to deflect one of thermal radiation of the first wavelength and visible light of the second wavelength, and to transmit the other, or to deflect both wavelengths differently, the radiation splitter being configured so as to pass the thermal radiation along a first optical path from the focussing optics assembly to the thermal radiation detector assembly, and to pass the visible light along a second optical path from the visible light source assembly to the focussing optics assembly.

The length of the first optical path is substantially equal to that of the second optical path, such that the focussing optics additionally forms a focussed image of the illuminated pattern of the visible light source assembly substantially on the focal plane, the illuminated pattern being configured to mark the location of the target region in the focal plane. The illuminated pattern includes a primary illumination region and at least one secondary illumination region, the primary illumination region having substantially the same lateral extent as the operative surface area of the thermal radiation detector assembly and being positioned such that the image of the primary illumination region formed at the focal plane falls substantially within and is substantially co-incident with the target region from which the thermal radiation detector assembly detects thermal radiation, and the at least one secondary illumination region being configured such that the image of the or each secondary illumination region formed at the focal plane is located outside the target region.

This invention relates to radiation thermometers for measuring the radiance or temperature of a target through the detection of thermal radiation. In particular, the invention concerns providing a radiation thermometer with sighting means whereby the area on a target surface from which radiation is being collected can be identified.

Radiation thermometers or “pyrometers” are used to take “spot” measurements of a body's temperature. The thermometer gathers radiation emitted from a small target region on a body using focussing optics. Thermal radiation is emitted by all materials at temperatures above absolute zero, travelling in the form of electromagnetic waves with a wavelength that will depend on the temperature of the body but is commonly in the infrared range 0.7 to 20 μm. Shorter, visible wavelengths down to 0.5 μm or less may be emitted by very hot objects. The region from which radiation will be collected by the thermometer will depend on the operative surface area of the radiation detector which is responsive to the thermal radiation and also on the configuration of the focussing optics. It is important that the user can identify where the target region is, relative to the thermometer, and preferably its extent, in order that radiation can be collected from the intended position on the body and hence the temperature of the correct object identified.

A number of approaches for enabling a radiation thermometer to project a visible light spot onto a target body in order to assist in identifying the location of the target region have been proposed. In many cases, one or more laser beams are projected from the radiation thermometer towards the target surface around the optic axis of the focussing system, and one such example is given in GB-B-2327493. Here, the laser beams are configured to diverge from one another along the optic axis at a similar angle to the convergence of the incoming thermal radiation, such that the size of the area defined between the laser beams increases roughly in proportion with the size of the target area as the distance between the thermometer and the target surface increases. This is achieved using a beam-splitting means constructed to sub-divide a single laser beam into a plurality of divergent sub-beams at an appropriate angle. However, this system can only be used in a fixed focus thermometer since the angle of laser beam divergence cannot be adjusted.

GB-A-2203537 discloses an arrangement in which a light source is projected through a lens system positioned in the unused volume of a cassegrain mirror system so as to project visible light along the same optic axis. The centre portion of the light source is masked so as to produce an area of visible light outlining a central dark region. The lens system is configured such that the outline encircles the target region at a particular focal distance. However, once again, such an arrangement can only be used in a fixed-focus thermometer and here, the outlining will only be correct at one specific position, incorrectly identifying the target region at all other locations in front of the thermometer.

A further problem encountered during the use of systems such as those disclosed in GB-B-2327493 and GB-A-2203537 is that, in practice, it is extremely difficult for the user to determine when the thermometer is correctly focussed on the desired target region. It is difficult to tell when the circle of visible light or light spots produced in either of the known devices is correctly sized so as to represent the focal plane, since the visible spots or outline will generally appear to expand or contract as the device is moved towards or away from the body, without clearly identifying the correct focus position.

As such, it would be desirable to provide a radiation thermometer with a sighting means which assists the user in determining when the radiation thermometer is correctly focussed on the target and, preferably, is suitable for use in thermometers with adjustable focus.

U.S. Pat. No. 3,441,348 discloses another example of a sighting device for a radiation thermometer which is similar to that of GB-A-2203537 and also fails to precisely identify the target region.

US-A-2005/0279940 and U.S. Pat. No. 4,494,881 disclose further examples of radiation thermometers with sighting systems in which a light source provided in the thermometer is imaged exactly on to the target region. However, in practice this requires the target region to be sufficiently large (e.g. at least several millimetres in diameter) so as to render the image visible to a user from a distance, thereby reducing the positional accuracy of the instrument.

In accordance with the present invention, a radiation thermometer comprises: a thermal radiation detector assembly having an operative surface area responsive to thermal radiation of a first wavelength; a focussing optics assembly adapted to focus both thermal radiation of the first wavelength and visible light of a second wavelength along an optical axis, the focussing optics assembly being configured to form a focussed image of the operative surface area of the thermal radiation detector assembly on a focal plane outside the radiation thermometer, the focussed image of the operative surface area defining a target region from which the thermal radiation detector assembly detects thermal radiation; a visible light source assembly adapted to exhibit an illuminated pattern of visible light of the second wavelength, the visible light source assembly comprising at least one visible light source and a mask through which light from the at least one visible light source is arranged to pass, the mask having one or more substantially opaque portions and one or more translucent portions arranged to define the illuminated pattern; and a radiation splitter adapted to deflect one of thermal radiation of the first wavelength and visible light of the second wavelength, and to transmit the other, or to deflect both wavelengths differently, the radiation splitter being configured so as to pass the thermal radiation along a first optical path from the focussing optics assembly to the thermal radiation detector assembly, and to pass the visible light along a second optical path from the visible light source assembly to the focussing optics assembly; wherein the length of the first optical path is substantially equal to that of the second optical path, such that the focussing optics additionally forms a focussed image of the illuminated pattern of the visible light source assembly substantially on the focal plane, the illuminated pattern being configured to mark the location of the target region in the focal plane; and wherein the illuminated pattern includes a primary illumination region and at least one secondary illumination region, the primary illumination region having substantially the same lateral extent as the operative surface area of the thermal radiation detector assembly and being positioned such that the image of the primary illumination region formed at the focal plane is substantially co-incident with the target region from which the thermal radiation detector assembly detects thermal radiation, and the at least one secondary illumination region being configured such that the image of the or each secondary illumination region formed at the focal plane is located outside the target region.

By providing a radiation thermometer with a visible light source assembly exhibiting an illuminated pattern and a radiation splitter in this way, the radiation thermometer can output a visible light pattern which is precisely in register with the target region of an object under test from which the thermal radiation is collected by the detector. This is because the radiation splitter combines the visible light onto the same optical path as the thermal radiation, for focussing by the same focussing optics assembly. Since the optical paths between the thermal radiation detector assembly and the focussing optics assembly, and between the visible light source assembly and the focussing optics assembly, are of substantially the same length, the focussing optics assembly will form focussed images of the thermal radiation detector assembly and visible light source assembly in substantially the same plane. Hence, if the focal power of the focussing optics assembly is changed, both images will be re-positioned in the same new focal plane, such that the system will automatically account for adjustable focus.

Moreover, by providing an illuminated pattern of visible light defined by a mask, the edges of the pattern delineating the illuminated portion(s) from the dark portion(s) are reproduced sharply in the focussed image of the pattern. In contrast with a conventional laser spot (which typically decrease gradually in intensity at their edges, resulting in an ill-defined periphery), it is straightforward for a user to observe the edges in the projected light pattern, determining that the thermometer is in focus when the edges appear sharp rather than blurred. The use of a mask to define the pattern also enables any desired pattern to be projected in order to achieve the marking. This is not possible using laser beams which are generally restricted to providing one or more bright spots of light. This substantial design freedom can be used to optimise the projected pattern for assisting the observer in determining when the thermometer is in focus, as discussed further below.

By providing a primary illumination region of substantially the same lateral extent as the target region and falling within the target region, the location of the target region and its size is clearly denoted by the illuminated pattern. This allows the user to accurately align the thermometer with the object to be measured by orientating the device such that the primary illumination region falls entirely on the object to be measured.

By additionally providing the illuminated pattern with one or more secondary illumination regions outside the target region, a large surface area compared with that of the target region itself can be made bright and optionally be used to direct the user towards the target region, thereby identifying its location, size and/or shape. Since the size of the secondary illumination region(s) is not constrained by or indeed related to the size of the target region, a much larger surface area can be made bright, enabling the pattern to be easily identified from a distance and further allowing the user to perceive detail in the pattern in order to determine whether or not the pattern, and hence the thermometer, is correctly focussed on the target surface. This is the case irrespective of the size of the target region and hence small target regions can be implemented, thereby maintaining the positional sensitivity and accuracy of the instrument. In some cases, at least one of the secondary illumination regions preferably identifies at least one position on the periphery of the target region. In one example, the secondary illumination regions outside the target region could comprise a set of arrows, each pointing towards the target region and ending, for example, on the periphery of the target region.

By providing both a primary illumination region highlighting the target region and one or more secondary illumination regions located outside the target region, the primary illumination region effectively forms part of a larger pattern of bright regions extending outside the target region in the focal plane. This provides the significant benefit that the target region itself will be demarcated, whilst the overall size of the pattern will be increased by the secondary illumination regions. This increases the overall brightness of the visible light pattern, aiding the user's observation of the pattern and enabling the user to perceive detail in order to easily identify whether the pattern is in focus. Further, the one or more secondary illumination regions can be configured to draw the user's eye toward the primary illumination region for ease of identification.

It will be understood that where the radiation splitter is described as “transmitting” either thermal radiation of the first wavelength or visible light of the second wavelength and “deflecting” the other, this does not require that 100% of each wavelength is either deflected or transmitted. Rather, where for example the radiation splitter is adapted to transmit thermal radiation and to deflect visible light, this means that the radiation splitter transmits a larger proportion of the thermal radiation than it deflects and it deflects a larger proportion of the visible light than it transmits. Similarly, where the radiation transmitter is adapted to transmit visible light and to deflect thermal radiation, a larger proportion of thermal radiation is deflected than transmitted, and a larger proportion of visible light is transmitted rather than deflected.

Where the radiation splitter is described as “passing” radiation, this encompasses both deflection and transmission. “Deflection” encompasses both reflection (e.g. by a mirror or dichroic filter) and diffraction (e.g. by a diffraction grating).

By “marking” the location of the target region in the focal plane, it is meant that the target region is identified in terms of its position, size and/or shape (preferably all three) by the image of the illuminated pattern in the focal plane. Various examples will be given below.

The mask preferably defines the illuminated pattern in a flat plane, such that substantially all points of the pattern will be focussed on the same plane by the focussing optics. The mask is located between the at least one visible light source and the radiation splitter, and the second optical path is defined between the mask and the focussing optics assembly.

The mask can be formed in various different ways and, in a preferred embodiment, the mask comprises a sheet of substantially opaque material having one or more apertures therethrough forming the one or more translucent portions. That is, the mask material is absent in the regions of the one or more translucent portions. For example, the mask could comprise a self-supporting sheet of metal, polymeric material or the like, from which the one or more apertures have been cut out by laser or physical machining, for instance. Such implementations have the significant advantage of high robustness and long lifetime.

However, the level of detail in the pattern which is obtainable may be limited and, in particular, it is not possible to include isolated opaque regions wholly surrounded by translucent portions as there would be no support for the isolated opaque portion of the mask. Therefore, in alternative preferred embodiments, the mask comprises a sheet of translucent, preferably transparent, material of which one or more portions are opacified, thereby forming the one or more substantially opaque portions. Such an arrangement increases the design freedom since isolated, opaque portions of the pattern can be supported by the translucent material. Similarly, high resolutions patterns which might not be sufficiently robust to be formed as cut-outs can also be supported.

This can be implemented in a number of ways. For example, the translucent material may act as a support layer for the mask. In one preferred embodiment the opacified portion(s) of the sheet comprise a layer of substantially opaque material applied to the translucent material. For instance, the translucent material could be a sheet of glass or a substantially transparent plastic and the substantially opaque material could be a layer of metal applied to the glass or plastic by sputtering or any other deposition technique. The pattern could be formed by etching the applied metal or using photo-patterning techniques, for example.

In alternative implementations, the opacified portions could be integral parts of the sheet material, which have been modified to exhibit a higher optical density than other areas of the sheet material. For example, the sheet material could be an intrinsically transparent photosensitive material of which portions have been exposed to light and subsequently developed to increase their optical density. Alternatively, in a particularly preferred embodiment, the mask could comprise a liquid crystal display (LCD). Typical liquid crystal displays comprise a liquid crystal layer sandwiched between crossed-polar filters and shaped electrodes which can be used to cause selected regions of the display to pass light, whilst others become substantially opaque. In this way, the pattern displayed by the mask can be changed through control of the LCD electrodes. This could be used, for example, to provide the thermometer with different illuminated patterns, e.g. for use in different modes of operation, or if desired, with an animated illuminated pattern which could be used to assist in drawing the eye of the user toward the target region. An LCD could be used to form only a part of the mask, combined with a static patterned region if desired.

The one or more visible light sources used to illuminate the mask pattern can take any form, provided that light is emitted over a sufficiently wide area in order to illuminate all the desired translucent portions of the mask (it is of course possible for the mask to include one or more translucent portions which will not be illuminated and thus do not contribute to the projected light pattern, but this is of little benefit). In preferred examples, the or each visible light source comprises a light emitting diode, defocused laser, incandescent lamp or an electroluminescent material.

In order that the projected visible light image is sufficiently bright to enable easy observation by the user, the at least one visible light source is preferably of high output power. For example, in preferred embodiments, the or each light source is adapted to emit visible light of the second wavelength at a wattage between 10 mW and 5 W.

The colour of the visible light may be selected according to the environment in which the radiation thermometer is to be used. Generally, it is desirable to select a colour which will stand out clearly against the expected environment. In general terms, any visible wavelength could be selected but, preferably, the second wavelength is in the range of 400 to 700 nm. In many industrial settings, it has been found that a green pattern provides the strongest level of contrast with the background and also provokes a strong response in the human eye. Therefore, in particularly advantageous embodiments, the second wavelength is in the range 400 to 620 nm, more preferably 400 to 590 nm, still preferably 470 to 590 nm, most preferably between 534 and 540 nm. It will of course be understood that, in practice, the visible light source assembly will emit a range of wavelengths which includes, and is preferably centred on, the second wavelength. However, account must also be taken of the wavelength(s) to be detected by the thermal radiation detector assembly, since the visible light wavelength in use must be different. For instance, in some cases, such as where the bodies whose temperature are being measured are expected to be glowing white hot and visible thermal radiation is to be detected, e.g. around 500 nm, a red visible pattern has found to be effective and, hence, the visible light source assembly may be configured to emit longer visible wavelengths in the range of 620 to 750 nm. Preferably, the waveband emitted by the visible light source assembly has little or no overlap with the waveband to which the thermal radiation detector assembly is responsive. However, this is not essential since the radiation splitter or another filtering component may prevent the emitted wavelength from reaching the detector, thereby avoiding the effect of any overlap.

The at least one light source could be illuminated continuously during operation, or upon receipt of an “on” signal from the user. However, in preferred embodiments, the radiation thermometer further comprises a controller adapted to operate the at least one light source in a pulsed mode of operation, preferably at a pulse frequency of between 0.5 and 100 Hz, more preferably between 0.5 and 50 Hz. Pulsing the illumination of the light source(s) in this way can be used to avoid overheating of the light source. The pulsing may be so fast (e.g. about 30 Hz) that the illuminated pattern appears continuously illuminated to the human eye. However, in certain preferred implementations, the controller is adapted to pulse the light source at a pulse frequency which gives rise to visible flashing of the illuminated pattern, the pulse frequency preferably being between 0.5 and 30 Hz, more preferably between 2 and 10 Hz. This assists in drawing the attention of the user to the illuminated pattern and hence to the location of the target region.

The thermometer could be configured to apply such pulsing whenever in use. However, preferably the pulsed mode of operation and preferably the pulse frequency is selectable by the user. That is, the user can select whether the light source(s) are pulsed and, if so, the frequency. In practice, this may be implemented by enabling the user to select a pulse frequency within a range which includes frequencies at which the pattern will appear to flash (e.g. less than about 30 Hz) as well as higher frequencies at which the pattern will appear steady.

If desired, where more than one light source is provided, only selected ones of the light sources may be pulsed, with others being constantly illuminated.

The primary illumination region of the visible light pattern could mark the target region in a number of different ways. For instance, the region could be in the shape of a cross-hair centred on the midpoint of the target region and sized such that the extremity of the cross-hairs meets the edges of a target region (thereby having the same lateral extent as the target region). Alternatively, one or more points on the periphery of the target region could be illuminated, possibly forming a full outline of the region. However, in particularly preferred embodiments, the primary illumination region is of substantially the same shape and size as the operative surface area of the thermal radiation detector assembly, the primary illuminated region being positioned such that the image of the primary illumination region formed at the focal plane is substantially co-incident with the target region from which the thermal radiation detector assembly detects thermal radiation. By providing a primary illumination region which matches the operative surface area of the radiation detector in this way, substantially the whole of the target region in the focal plane is illuminated and its periphery is clearly defined by the extent of the bright region, thereby identifying its position, size and shape in the focal plane. This enables the user to determine exactly what body surface(s) are emitting thermal radiation into the detector so that it can be ensured that a precise measurement of the correct surface is being taken. Further, since substantially the whole of the target region is illuminated, the target spot is brighter than would be the case if only a portion of the region, or only an outline thereof, is illuminated. This assists the user in identifying the illuminated pattern on the target surface and determining whether it is in focus. Typically, all of the illumination regions will be illuminated by the same visible light source and hence will appear in the same colour. However, this is not essential since, light sources having more than one wavelength could be utilised in the visible light source assembly, or coloured filter(s) could be incorporated into or alongside the mask to change the apparent colour of selected illuminated regions. For example, the primary illumination region could appear in a first colour (e.g. green) whilst the secondary illumination regions could appear in a second colour (e.g. blue).

The illuminated pattern could take any desirable configuration and the one or more secondary illumination regions could all be positioned on one side of the target region if desired. However, where the illuminated pattern includes a plurality of secondary illumination regions, it is advantageous if the target region is located between images of the secondary illumination regions in the focal plane. In other words, the secondary illumination regions will be positioned on either side of the target region to assist in defining its position and extent between the secondary illumination regions. In particularly preferred embodiments, the secondary illumination regions are configured such that the images of the secondary illumination regions are rotationally symmetrical around the target region in the focal plane. It should be noted that full rotational symmetry is not required. Rather, the pattern may have two fold rotational symmetry, three fold rotational symmetry, or four fold rotational symmetry, etc. Patterns of this sort have been found to be particularly effective in drawing the user's eye to the central target region.

As noted above, in particularly advantageous implementations the primary illumination region forms part of a larger pattern of illuminated regions, the image of which in the focal plane extends beyond the target region in at least one direction, preferably in all directions. The illuminated pattern can take many different forms but is preferably designed to assist the user in determining when the image of the pattern is correctly in focus. Thus, the pattern is preferably configured such that when viewed some distance in front of or behind the focal plane, the imaged pattern is clearly blurred, exhibiting, for example, the meeting or overlapping of more than one illuminated region. Thus, in particularly preferred embodiments, the illuminated pattern includes at least two illuminated regions separated from one another by a non-illuminated region. The spacing between the illuminated regions should be relatively small such that, when out of focus, the at least two illuminating regions will clearly blur, possibly leading to merging or overlapping. In preferred examples, the at least two illuminated regions are spaced at at least one point where no more than 1 mm, preferably no more than 0.5 mm, more preferably no more than 0.1 mm, still preferably no more than 0.05 mm. It will be appreciated that these are the measurements of the illuminated pattern on the mask, and the dimensions in the projected image will depend on the degree of magnification achieved by the focussing optics. It will also be understood that the at least two illuminated regions need not be spaced along their full extent by the same distance. Rather, it is preferred that at at least one location, the two illuminated regions approach one another at the distances mentioned.

In order to further assist the user in determining when the image of the illuminated pattern is in focus, in particularly preferred embodiments, the illuminated pattern comprises at least one, preferably a plurality of, straight edges between illuminated and non-illuminated regions. The present inventors have found that degrees of blurring of straight edges in the visible light pattern are more readily discernable by an observer and hence it is advantageous to include one or preferably a plurality of straight edges in the pattern. More generally, the present inventors have found that blurring of the visible light pattern can be more readily perceived by the observer where the pattern has a relatively high proportion of edges compared with the overall surface area of the bright regions. In particular, it is preferred that the ratio R should have a value greater than 4, preferably greater than or equal to 10, more preferably greater than or equal to 15, and preferably less than or equal to 50, more preferably less than or equal to 25, most preferably in the range 15 to 25, where R is defined as:

$$R = \frac{p}{a} \cdot d$$

### Where:

p=total perimeter of illuminated region(s) of illuminated pattern;
a=total area of illuminated region(s) of illuminated pattern; and
d=diameter of illuminated pattern.

For comparison, a single illuminated circle or square would have a value of R equal to 4, which is less than that of the preferred patterns. However, very high values of R (e.g. greater than 50) are generally not advantageous since, here, the pattern will tend to be made up of narrow line elements which will be difficult to make out due to their very high aspect ratio.

The illuminated pattern can take any configuration which assists in the manner described above, so might for example comprise a symbol, a geometric shape or one or more arrows. However, the illuminated pattern could also be used to carry information and therefore could comprise, for example, alphanumerical text, a logo or other graphic. For example, the illuminated pattern could display the logo of the thermometer manufacturer or another brand name or symbol. Where the pattern is changeable (e.g. through the use of a LCD in the mask) the pattern could switch between one or more of the above example types. In some particularly preferred examples, the pattern could include information concerning the measurement being taken. For example, the pattern could be configured to exhibit alphanumeric text giving the currently measured temperature, based on an output from the thermal radiation detector.

More generally, the displayed pattern could also be made changeable by utilising a plurality of visible light sources and controlling different light sources to be switched on and off in sequence such that different portions of the mask are illuminated at any one time. Thus the illuminated pattern could be animated.

The thermal radiation detector assembly will comprise at least one thermal radiation detector which is responsive to thermal radiation of the first wavelength and the operative surface area of the assembly may be defined by that of the detector itself. However, in preferred embodiments, the thermal radiation detector assembly further comprises a field stop disposed between the at least one thermal radiation detector and the radiation splitter, the field stop defining the operative surface area of the thermal radiation detector assembly, and the first optical path being defined between the field stop and the focussing optics assembly. The field stop may be used, for example, to decrease the size of the target region to thereby increase the precision of the instrument or to configure the shape of the operative surface area and hence the target region. For certain applications, different target region shapes may be desirable. For instance, if the thermometer is to be employed to measure the temperature of a “cavity” such as that formed between a roller and a hot metal sheet (as described in our International Patent Application No. PCT/GB2009/000173), an elongate operative surface area of the detector assembly may be desirable. This could be achieved, for example, by providing the field stop with a long rectangular or triangular aperture.

The operative surface area of the thermal radiation detector assembly can be positioned off-centre if desired, in which case the primary illumination region in the visible light pattern will be off-centred to the same degree. However, in particularly preferred embodiments, the operative surface area defined by the field stop is approximately centred on the axis of the first optical path (and therefore the primary illumination region will similarly be approximately centred on the axis of the second optical path). Like the illuminated pattern, the operative surface area can take any desirable shape such as that of a circle, square, rectangle, oval, triangle, a letter, number, alphanumerical text, a symbol or any other shape, which will be matched by that of the primary illumination region included in the visible light pattern.

The at least one thermal radiation detector can be responsive to any wavelength of thermal radiation through selection of the detector structure and materials. In particularly preferred embodiments, the thermal radiation of the second wavelength which will be detected by the thermal radiation detector assembly comprises visible and/or infrared radiation. For example, the second wavelength preferably lies between 0.5 and 14 μm, more preferably 0.7 to 10 μm. Of course, in practice the thermal radiation detector will be responsive to a band of wavelengths including the second wavelength and preferably centred on the second wavelength.

The thermal radiation detector is preferably substantially non-responsive to wavelengths emitted by the visible light source assembly, such that the signal output by the detector is not significantly influenced by the visible light pattern formed on the target surface or by any internal reflections of the visible light within the thermometer body. For instance, in one embodiment, the thermal radiation detector is responsive to an infrared wavelength in the range 0.7 to 10 μm (i.e. the second wavelength lies between 0.7 and 10 μm—the detector need not be responsive to the whole wavelength range mentioned), whilst the visible light source assembly emits green light of around 530 nm (0.530 μm). In another example, the thermal radiation detector may be responsive to visible light, e.g. around 500 nm which is emitted by very hot bodies when glowing white. In this scenario, the visible light emitted by the visible light source assembly might be red for example, e.g. around 700 nm.

The radiation splitter can take any appropriate form which is able to treat the two wavelengths (or wavebands) used in the thermometer differently from one another. This may involve primarily reflecting or diffracting one whilst primarily transmitting the other, or deflecting both wavelengths differently, e.g. through different deflection angles and/or in different directions. In preferred examples, the radiation splitter may comprise a dichroic mirror or a diffraction grating. A dichroic mirror or interference mirror is a thin film interference structure comprising alternating layers of optical coatings with different refractive indices which can be configured to transmit selected wavelengths whilst reflecting others.

In a first preferred implementation, the radiation splitter is adapted to transmit thermal radiation of the first wavelength and to deflect visible light of the second wavelength, the thermal radiation detector assembly being disposed on the optical axis of the focussing optics system and the visible light source assembly being disposed off the optical axis, the radiation splitter being configured to intercept the optical axis between the thermal radiation detector assembly and the focussing optics assembly and to deflect visible light of the second wavelength from the visible light source assembly onto the optical axis. This may be achieved, for example, by using a cold mirror as the radiation splitter. A cold mirror is an example of a dichroic mirror, which transmits longer wavelengths and reflects shorter wavelengths. For example, a cold mirror may be used to transmit infrared wavelengths whilst reflecting shorter green visible wavelengths. Alternatively, if visible thermal radiation is to be detected, a hot mirror might be used instead, which is an example of a dichroic mirror able to transmit shorter wavelengths and reflect longer wavelengths.

In another implementation, the radiation splitter is adapted to transmit visible light of the second wavelength and to deflect thermal radiation of the first wavelength, the visible light source assembly being disposed on the optical axis of the focussing optics system and the thermal radiation detector assembly being disposed off the optical axis, the radiation splitter being configured to intercept the optical axis between the visible light source assembly and the focussing optics assembly and to deflect thermal radiation of the first wavelength from the optical axis towards the thermal radiation detector assembly.

Again, a hot or cold mirror could be used as the radiation splitter depending on which wavelengths are in use.

In a further embodiment, the radiation splitter is adapted to deflect the thermal radiation of the first wavelength from the optical axis towards a first position off the optical axis at which the thermal radiation detector assembly is situated and to deflect visible light of the second wavelength from a second position off the optical axis at which the visible light source assembly is situated onto the optical axis. This could be achieved, for example, using a reflective or transmissive diffraction grating.

In some cases, the radiation splitter may be arranged such that the optical paths between the thermal radiation detector assembly and the radiation splitter, and between the visible light source assembly and the radiation splitter are orthogonal to one another. However, in particularly preferred examples, the angle between the light paths is less than 90 degrees. Thus the two assemblies are positioned more closely alongside one another, thereby allowing for a reduction in the dimensions of the thermometer. Preferably, the angle subtended between the thermal radiation detector assembly and the visible light source from the radiation splitter is either:
acute, preferably 60 degrees or less, more preferably 45 degrees or less, most preferably 30 degrees or less; or
obtuse, preferably 120 degrees or more, more preferably 135 degrees or more, most preferably 150 degrees or more.

The focussing optics system could be implemented in a number of ways provided it is effective to focus both of the wavelengths (the thermal radiation and visible light) in use. In general, it is preferred that the focussing optics system comprises a curved mirror system adapted to perform the focussing, since such reflection-based focussing system will tend to be largely achromatic, applying the same focussing power to both wavelengths. In particularly preferred embodiments the focusing optics system is implemented as a cassegrain mirror system.

However, in alternative embodiments, the focussing optics system could be implemented as a lens assembly of one or more lenses. Particularly in this case, it may be necessary to apply additional focus adjustments to one or both of the wavelengths outside the focussing optics assembly, since the lens system may operate with a greater focussing power on one wavelength than the other (being based on a refractive mechanism). Hence, advantageously, the radiation thermometer further comprises at least one focus compensation element disposed in the first or second optical path, the focus compensation element(s) being adapted to compensate for any chromatic focal shift in the focussing optics system. For example, one or more additional lens elements could be inserted between the thermal radiation detector assembly and the radiation splitter, or between the visible light source assembly and the radiation splitter to achieve such compensation.

As already mentioned, the disclosed sighting arrangement is suitable for use in devices of adjustable focus and this adjustment can be achieved in a number of different ways. In one preferred implementation, the length of the first and second optical paths is adjustable to thereby adjust the position of the focal plane relative to the focussing optics system along the optical axis. By changing the optical path length inside the thermometer, the position of the focal plane will change by a corresponding amount. However, the length of the first and second optical paths should not change relative to one another in order to preserve focussing of the target region and visible light pattern in the same plane.

In one preferred implementation, the thermal radiation detector assembly, the visible light source assembly and radiation splitter are fixed in relation to one another, forming a unit which is movable relative to at least a part of the focussing optics system to enable the length of the first and second optical paths to be adjusted. Thus, for example, the detector, light source and radiation splitter unit may be moved, or the focussing optic system may be moved or at least a part of the focussing optic system may be moved in order to achieve the desired focal adjustment. For example, in a cassegrain mirror system, only one or the other of the two main mirror components may be moved in order to change the focussing power of the focussing optic system.

Preferably, the radiation thermometer further comprises a processor adapted to receive a signal output by the thermal radiation detector assembly representative of the thermal radiation detected, and to compute the radiance and/or the temperature of the target region from the signal. This could take the form of an analogue circuit board or a digital microprocessor, for example. As mentioned above, if the illuminated pattern is changeable, the computed radiance and/or temperature could be outputted to the illuminated pattern under the control of the processor for projection onto the target surface.

In some embodiments, this projection could be the sole means for outputting the result of the measurement but, in preferred implementations, the device further (or alternatively) comprises an output module for outputting the computed radiance and/or temperature, preferably a display or a communications port for transmitting the computed radiance and/or temperature to an external device.

The radiation thermometer could be powered using one or more onboard power supplies such as a battery or solar cell, but in most preferred embodiments, the radiation thermometer is adapted to receive power from a mains power supply. This is advantageous since high power light sources are preferred in order to achieve high brightness of the illuminated pattern.

The radiation thermometer could be portable and/or hand held but in preferred examples, the device is configured for static use and is adapted to be fixedly mounted, e.g. on a stand or to a wall, etc.

The radiation thermometer may further comprise a sight, aligned with the optical access to enable the user to ascertain the device's field of view. However, in preferred implementations, sighting is achieved through the use of a visible light camera configured to have a field of view including the target region and a monitor for display of the image received by the visible light camera. The components required for such an implementation can be configured in a compact manner and avoid the need to provide an additional visible optical path through the thermometer itself.

The present invention further provides a radiation thermometer assembly comprising a radiation thermometer as described above and a water-cooled jacket configured to shield the radiation thermometer from the ambient temperature. The radiation thermometer assembly may further or alternatively comprise a purging assembly configured to direct a flow of purging gas, preferably air, onto at least part of the focussing assembly.

Also provided is a method of identifying the target region of a radiation thermometer as described above, comprising directing the radiation thermometer towards an object, the temperature of which is to be measured, and activating the at least one light source such that the object is illuminated by the illuminated pattern, whereby the location of the target region is identified by the primary illumination region.

Preferably the method further comprises adjusting the distance between the radiation thermometer and the object and/or adjusting the focal power of the radiation thermometer such that a surface of the object is substantially coincident with the focal plane of the radiation thermometer.

Advantageously the method further comprises pulsing the activation of the at least one light source preferably at a pulse frequency of between 0.5 and 100 Hz, more preferably between 0.5 and 50 Hz. Preferably, the light source is pulsed at a pulse frequency which gives rise to visible flashing of the illuminated pattern, the pulse frequency preferably being between 0.5 and 30 Hz, more preferably between 2 and 10 Hz.

Examples of radiation thermometers and methods of identifying the target region of a radiation thermometer will now be described with reference to the accompanying drawings in which:

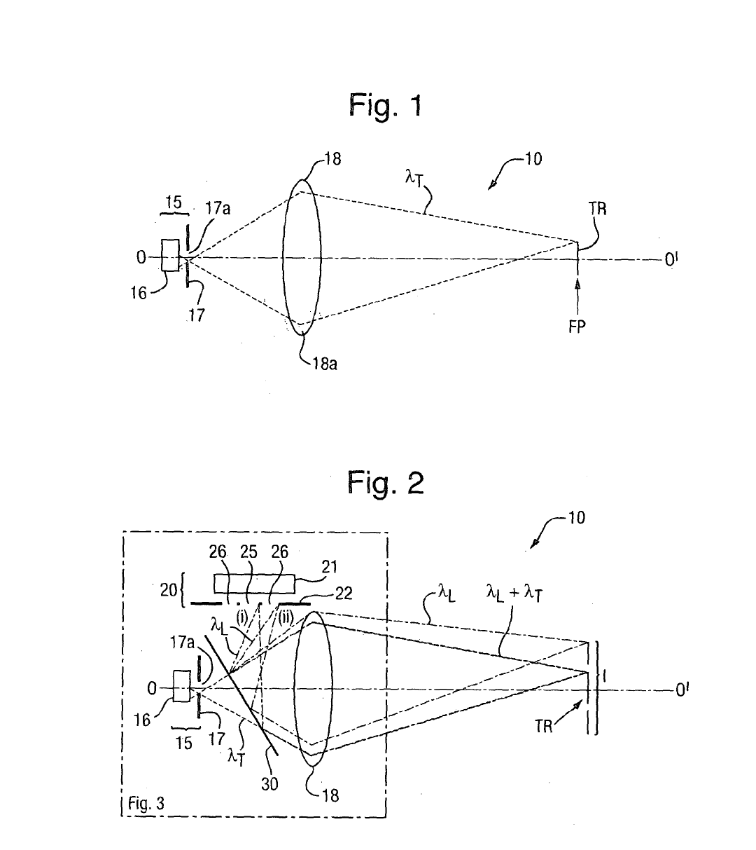

FIG. 1 schematically depicts selected components of a first embodiment of a radiation thermometer, showing the path of thermal radiation through the device;

FIG. 2 schematically depicts the radiation thermometer of FIG. 1, showing further components providing an additional visible light path through the device;

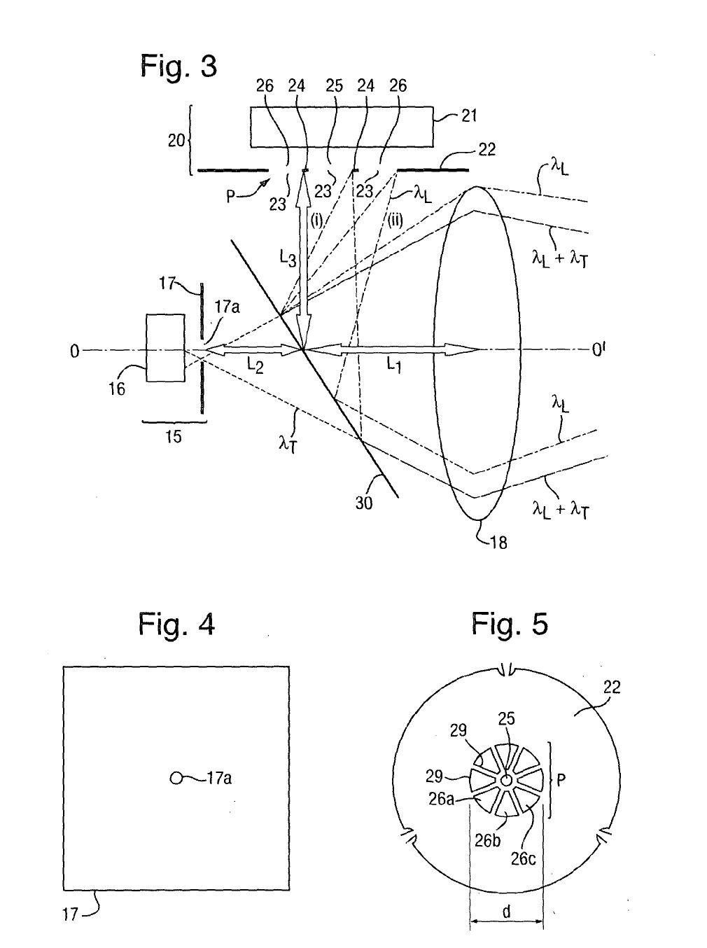

FIG. 3 shows an enlarged detail of FIG. 2;

FIG. 4 depicts an exemplary field stop for use in the first embodiment;

FIG. 5 depicts an exemplary mask for use in the first embodiment;

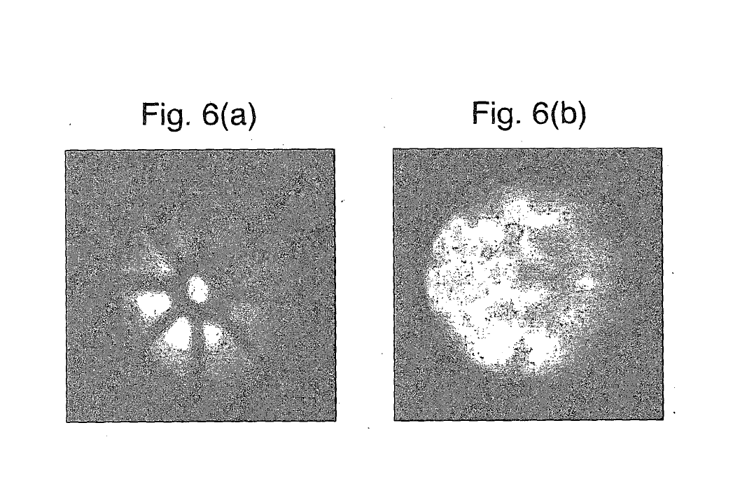

FIGS. 6(a) and 6(b) illustrate the appearance of an exemplary visible light pattern—(a) in focus and (b) out of focus;

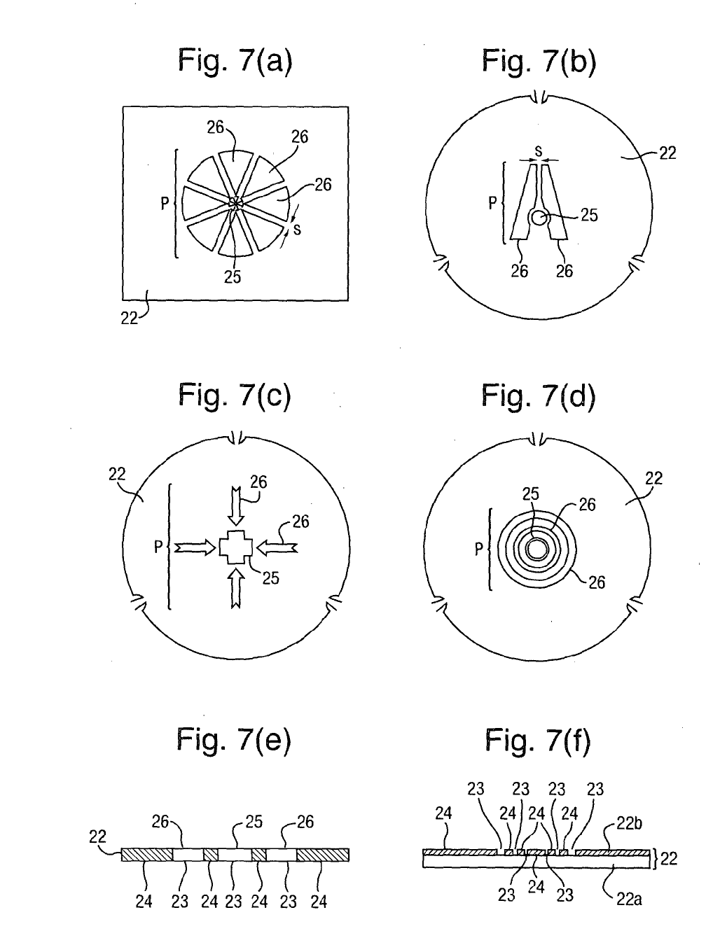

FIGS. 7(a) to (f) illustrate exemplary masks for use in further embodiments, FIG. 7(e) depicting a cross-section through the mask of FIG. 7(c) and FIG. 7(f) depicting a cross-section through the mask of FIG. 7(d);

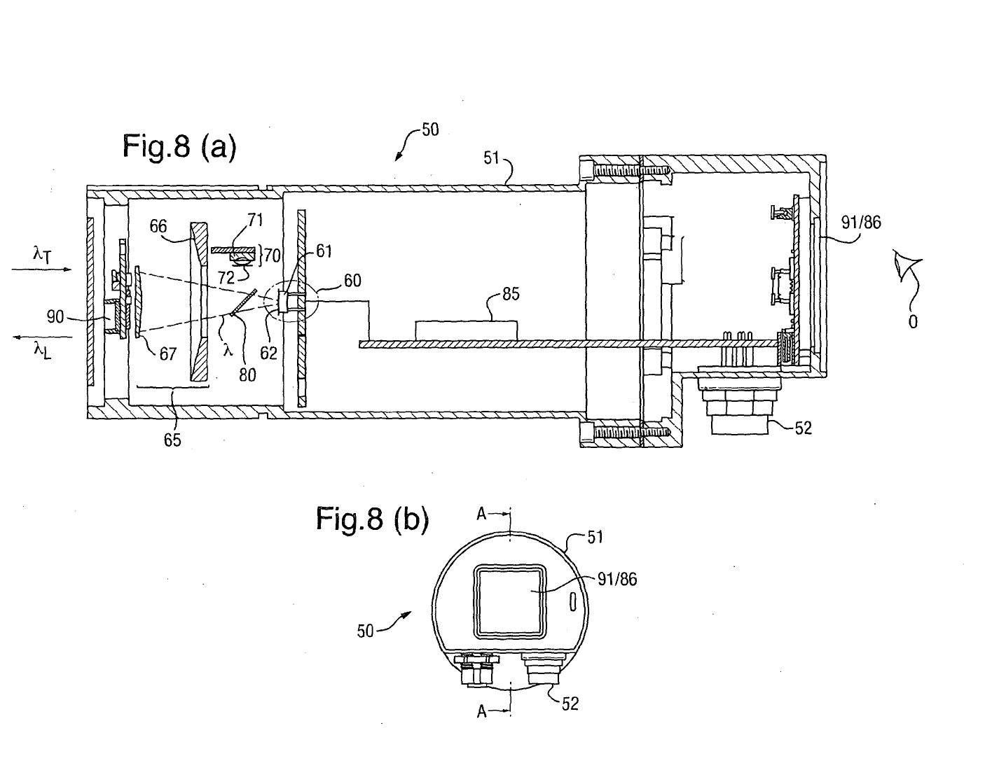

FIG. 8a is a cross-section through a second embodiment of a radiation thermometer and FIG. 8b shows the same radiation thermometer from one end;

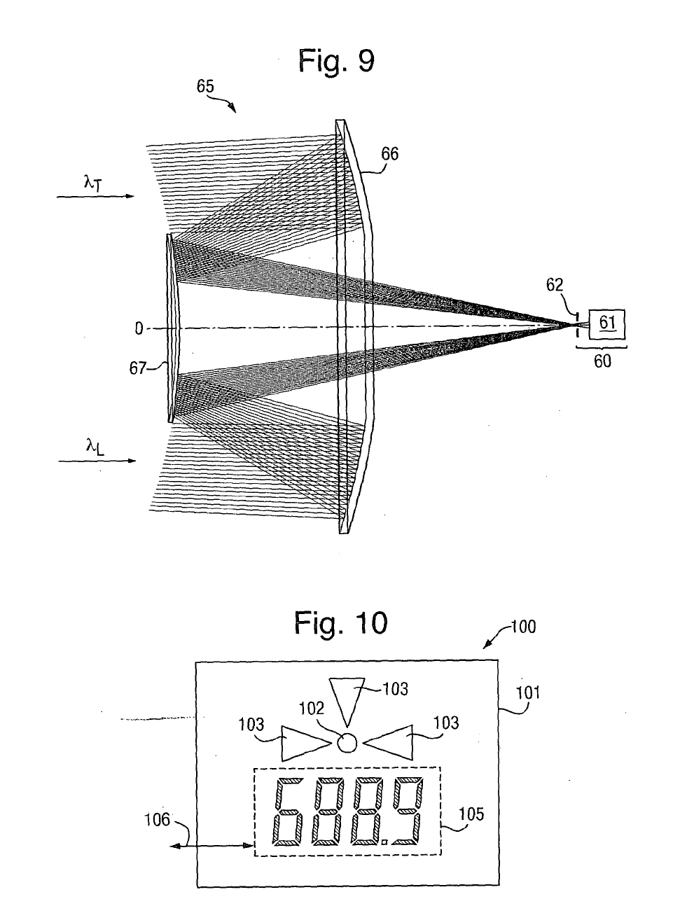

FIG. 9 schematically depicts the focussing optics assembly of the second embodiment in isolation, other components having been removed for clarity;

FIG. 10 depicts an exemplary mask for use in a third embodiment;

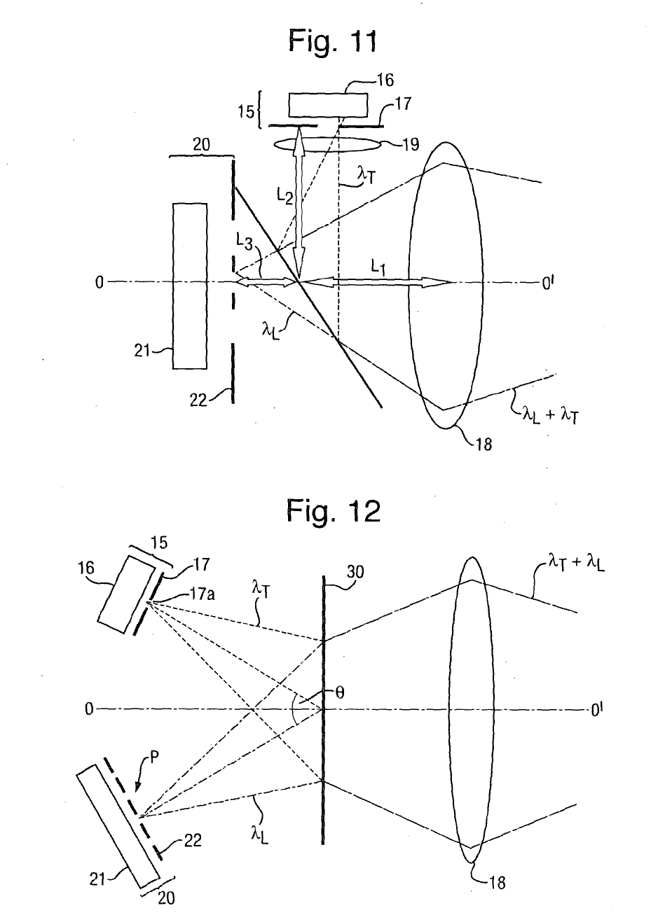

FIG. 11 depicts a portion of a fourth embodiment of a radiation thermometer;

FIG. 12 shows a portion of a fifth embodiment of a radiation thermometer; and

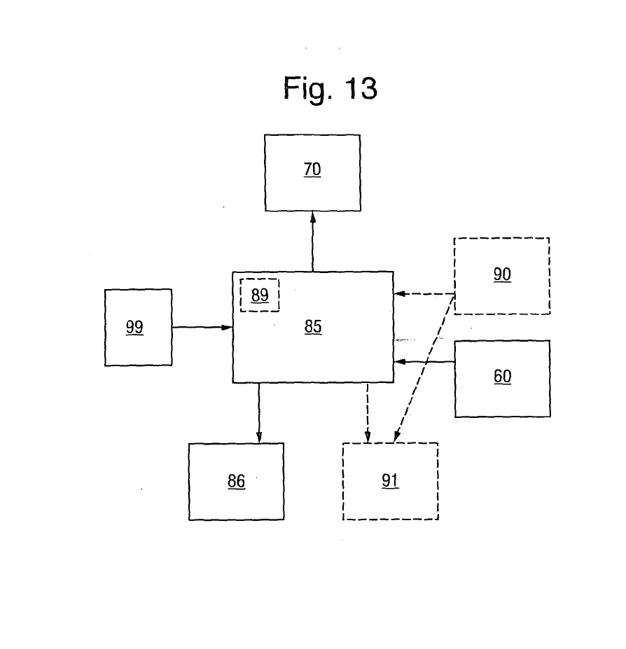

FIG. 13 is a block diagram illustrating the functional relationship between modules of a radiation thermometer in a further embodiment.

Radiation thermometers are used to determine the temperature or radiance of an object by collecting thermal radiation emitted from a small target region or “spot” on the object's surface. FIG. 1 illustrates selected components of a radiation thermometer in a first embodiment in order to show the path taken by thermal radiation through the device. A focussing optics assembly 18, here formed of lens 18a, is used to focus radiation from the body whose temperature is to be determined (not shown) onto a thermal radiation detector assembly 15. In this example, the detector assembly 15 comprises a thermal radiation detector 16 and a field stop 17 having an aperture 17a which defines the operative surface area of the detector assembly, i.e. that region which will give rise to a signal should thermal radiation of an appropriate wavelength fall on it. In practice, it may not be necessary to include a field stop 17 should it be desired to utilise the full surface area of detector 16 to detect radiation. However, as will become apparent, the size of the operative surface area determines the size of the “spot” on the object from which radiation will be collected and hence it is generally preferred to reduce the size in order to improve the spatial precision with which the thermometer can measure temperature.

The thermal radiation detector 16 can take various different forms (such as one or more photodiodes, photovoltaic or photoconductive materials, thermopiles, bolometers, microbolometers, thermocouples, or any combination thereof) and will generally be configured to be responsive to electromagnetic radiation of a particular wavelength or range of wavelengths (i.e. a waveband). The detector waveband will be selected according to the range of temperatures which the thermometer is intended to be able to measure. Typically, the thermometer will operate in the infrared range and hence the detector 16 may be responsive to a wavelength or waveband in the range 0.7 to 10 μm. However, alternative wavelength ranges may be preferred for certain applications. For instance, where the objects under test are of sufficiently high temperature so as to appear white hot, the detector may be selected to be responsive to visible wavelengths, e.g. a silicon detector responsive to approximately 500 nm might be used. In the Figures, the notation λ_{T} denotes the selected thermal radiation wavelength (or waveband).

FIG. 1 shows the path of two rays emitted from the top of the target region TR, being focussed by the lens 18a to just pass through the field stop 17 in order to be collected by the detector 16. In effect, the target region TR is defined by the image of the operative surface area of the detector assembly 15 formed by the lens 18a. Of course, since the detector assembly 15 does not emit any light, this image will not be visible to an observer unless their eye (or some other image detection device) is positioned at the location where the image is formed. Nonetheless, only thermal radiation emitted by the area of the target body on which the image of the operative surface area of the detector assembly 15 falls will be collected by the thermometer. Hence the size and shape of the target region TR will be determined by the size and shape of the operative area of the detector assembly 15, which limits the collected rays. The image representing the target region is formed in a focal plane (FP) whose distance in front of the thermometer will depend on the focal power of the lens 18a and the distance between the detector assembly 15 and the lens, referred to hereinafter as the first optical path.

FIG. 2 depicts the same radiation thermometer showing additional components for assisting the user in sighting the radiation thermometer, i.e. aligning the radiation thermometer with the correct position on the target object at which the temperature is to be measured. This is achieved by projecting a visible light pattern onto the same focal plane FP as the target region TR to thereby mark the location of the target region.

The radiation thermometer 10 is provided with a visible light source assembly 20 which exhibits an illuminated pattern P. The assembly comprises one or more visible light sources 21, such as an LED, a defocused laser, an incandescent lamp or electroluminescent material, and a mask 22 positioned in front of the light source 21 to define the pattern. The visible light emitted by the assembly 20 is denoted in the Figures as λ_{L}.

A radiation splitter 30 is inserted into the light path between the thermal radiation detector assembly 15 and the focussing optics assembly 18 in order to receive light λ_{L} emitted by the visible light source assembly 20 and combine it onto the same optical path through the focussing optics assembly 18 as that along which the thermal radiation λ_{T} passes. For example, in the present embodiment, the radiation splitter 30 comprises a cold mirror, which is a type of interference filter able to transmit one wavelength of radiation whilst reflecting another. Thus, in this example the cold mirror 30 is substantially transparent to the thermal radiation λ_{T} to which the detector 16 is responsive, so as not to obstruct the receipt of thermal radiation at the detection assembly. Meanwhile, the cold mirror 30 reflects visible light λ_{L} from the illuminated pattern P towards the target body through the focussing optics assembly 18. The visible light is thus focussed in the same manner as the thermal radiation, to result in a focussed image I of the illuminated pattern P which is visible to observers.

As shown best in the enlarged detail of FIG. 3, the detector assembly 15, light source assembly 20 and radiation splitter 30 are arranged such that the optical path length between the focussing assembly 18 and the radiation detector assembly 15 (the first optical path) is substantially equal to the optical path length between the focussing assembly 18 and the visible light source assembly 20 (a second optical path). Thus, the distances labelled as L₂ and L₃ in FIG. 3 are substantially equal (please note FIG. 3 is not to scale). The first optical path between the focussing optics assembly 18 and the detector assembly 15 is given by the sum of distances L₁ and L₂, whilst the second optical path between the focussing optics assembly 18 and the light source assembly is given by the sum of distances L₁ and L₃. Since the optical path lengths are substantially equal, the focussing optics assembly 18 will form the focussed image of the detector assembly (i.e. the target region, TR) and the focussed image of the illuminated pattern P (image I) in substantially the same focal plane, FP. Hence, if the visible image I of the illuminated pattern P appears in focus on the surface of the target body, the thermal radiation detector assembly 15 will also be focussed on that surface.

The illuminated pattern P defined by mask 22 can be configured in various different ways in order to mark where in the identified focal plane FP the target region TR is. The mask is preferably flat such that the full extent of the illuminated pattern will be focussed in the same plane FP. In general, the mask 22 will comprise one or more translucent regions 23 through which light emitted by the light source 21 can pass, and one or more opaque regions 24 which block the passage of the light. The translucent regions 23 will appear as bright, visibly illuminated areas of the visible light pattern I in the focal plane FP and are therefore designed to identify the target region to the observer. The illuminated pattern P comprises a primary illumination region 25 which has substantially the same lateral extent as the operative surface area of the detector assembly 15 (here defined by the field stop aperture 17a), preferably being of substantially the same shape and size, as is the case here. Through careful lateral positioning of the mask 22, this primary illumination region 25 can be arranged to coincide exactly with the image of the operative surface area in the focal plane defining the target region TR.

This is shown best in FIG. 2 where the visible light rays λ_{L} are depicted using “dash-dot” lines, and the thermal radiation λ_{T} in dashed lines. The mask 22 includes a central translucent region 25 which is shaped and sized to match the field stop aperture 17a. Illustrative light rays (i) are emitted from one edge of that region and, when reflected by the cold mirror 30, coincide with the thermal radiation ray path defined by the extremity of the field stop aperture 17a. Rays drawn from the opposite side of the illuminated region 25 (not shown) would coincide with the thermal radiation ray path defined by the opposite side of the field stop aperture 17a. The result is an illuminated region of the pattern I which fills exactly the same target region TR in the focal plane FP as that from which thermal radiation will be collected by the thermometer.

Thus, the target region is immediately identifiable by the user as it will appear bright on the surface of the body whose temperature is to be measured. Moreover, since not only the location but also the size and shape of the target region is illuminated, the user can clearly see the full extent of the target region, and thereby determine whether radiation is being collected from the intended object or not. For example, if the image of the primary illumination region 25 falls on an edge of the target object such that only half of the illuminated region is visible on the surface to be measured, the user will recognise this and can move the thermometer relative to the target object to reposition the target region in order that radiation from the intended object only can be fully collected.

Since the whole of the target region is illuminated in this embodiment, the overall appearance of the region is much brighter than would be the case if only selected portions of the region are illuminated, e.g. points on its periphery. This assists the user in making out the illuminated pattern in the ambient environment.

The illumination pattern also includes one or more secondary illumination regions 26 which form corresponding bright regions of the visible image outside the target region TR. Such secondary illumination regions 26 can be used to assist in identifying the target region, but primarily improve the effectiveness of the sighting means by increasing the overall brightness of the visible pattern (due to the increased illuminated surface area) and also increasing the available area for introducing detail to the pattern at a scale which will be visible to the user when the pattern is projected on a surface some distance in front of them. As described below, by increasing the amount of detail in the pattern, the user can tell more readily whether or not the pattern is blurred and hence whether the thermometer is correctly focussed.

In FIG. 2, the visible light rays marked (ii) are emitted from the outer extremity of one such secondary illumination region 26. The rays are reflected by the radiation splitter 30 onto the path marked λ_{L}, which is not coincident with that of the thermal radiation to form illuminated portions of the visible image I outside the target region TR. In this example, secondary illumination regions 26 are provided on either side of the primary illumination region 25 so that the target region TR is located between the images of the secondary illumination regions in the focal plane FP. However, in other examples, the secondary illumination region or regions 26 could be provided on only one side of the target region TR.

FIGS. 4 and 5 show, respectively, an exemplary field stop 17 which may be used in the thermal radiation detector assembly 15 and a mask 22 which may be used in the visible light source assembly 20 to form the illuminated pattern P. Here, the field stop 17 has a circular field stop aperture 17a centred on the axis of the first optical path (here this coincides with the optical axis of the focussing assembly, O-O′), thereby defining a circular operative detector area. The mask 22 carries translucent regions 25, 26 arranged to form a “sun”-type symbol. A central circular translucent region forms the primary illumination region 25 and thus corresponds in size, shape and lateral position to the field stop aperture 17a. Hence, in this example, the translucent region 25 is centred on the axis of the second optical path between the visible light source assembly 20 and the focussing assembly 18, but in other embodiments if the operative surface area of the detector assembly is off-axis then the primary illumination region of the mask will also be off-axis to the same extent. Surrounding the primary illumination region 25 in this example are eight segment-shaped translucent regions of which three are labelled 26a, 26b and 26c. These form secondary illumination regions which will be imaged outside the target region TR in the focal plane FP.

FIGS. 6a and 6b are photographs showing the appearance of the projected visible light pattern produced using a similar but not identical illuminated pattern P. FIG. 6a shows the appearance of the visible light pattern I when the instrument is (approximately) correctly focussed on a target surface and FIG. 6b shows an out of focus example. As seen in FIG. 6a, when the device is correctly focussed on the surface, a sharp image of the illuminated pattern P will be visible, with clearly defined bright and dark regions delineated by sharp edges. In contrast, when the device is not correctly focussed, the various sections of the illuminated pattern will appear blurred and may meet with or overlap one another such that the pattern as a whole is not clearly distinguishable, as shown in FIG. 6b. Thus, the appearance of a sharp, well defined illuminated pattern on the target surface can be quickly checked by the observer to confirm that the instrument is correctly focussed. If a blurred image is observed, this will be readily apparent, thereby enabling the operator to adjust the focus either by relative movement of the thermometer and target body or changing the focal power of the instrument itself (discussed further below). It is far easier to tell through simple observation whether a pattern of multiple bright regions is blurred compared with determining whether a small spot e.g. of laser light (as utilised in conventional radiation thermometers) is at its minimum diameter.

In FIG. 6a, the central circular region of the illuminated pattern corresponds to the target region TR from which radiation will be collected, whilst the “sun-ray” sections correspond to secondary illumination regions falling outside the target region.

The thermometer could be of a fixed-focus arrangement, in which case the spacing between the thermometer and the target surface will need to be adjusted to ensure the focal plane FP coincides with the target surface. However, to improve the flexibility of the thermometer, an adjustable focus implementation is preferred and the disclosed visible light sighting arrangement is entirely compatible with this. The focus position can be adjusted by:
Changing the length of the optical paths between the focussing optics assembly 18 and the thermal radiation detector assembly 15/visible light source assembly 20; and/or
Altering the focal power of the focussing optics assembly 18.

If the optical path lengths are to be altered, this is preferably achieved by moving the focussing optics assembly 18 along its optic axis O-O′ rather than moving the thermal radiation detector assembly 15 or visible light source assembly 20, since this will ensure that the two optical paths remain of equal length to one another. However, both components could alternatively be moved by the same distance. In another case, the thermal radiation detector assembly 15, visible light source assembly 20 and radiation splitter 30 may be formed as a unit which can be moved whilst its components remain in fixed relation to one another. Altering the focal power of the focussing optics assembly 18 is generally the preferred technique for implementing adjustable focus since this requires no relative movement outside the optics assembly. In a multi-lens focussing assembly, a change in focal power may be achieved by adjusting the spacing between lenses and similarly in a mirror-based system, the relative positions of the mirrors determine the focal position. Hence only part of the focussing assembly need be moved in order to adjust the focus. Since both the thermal radiation and the visible light travel along the same optical path through the focussing assembly, both will be affected by the change in focus to the same extent and hence the two images will continue to be formed in the same focal plane as one another.

The illuminated pattern could take many different configurations and some further examples will be described with reference to FIG. 7, any of which could be used as the mask 22 in the above-described embodiment. FIG. 7a is an example of a mask 22 comprising a plurality of translucent regions, including a primary illumination region 25 falling inside the target region TR in the focussed image of the pattern and secondary illumination regions 26 falling outside the target region. The layout of the pattern P corresponds largely to that depicted in FIG. 5, but here the central circle has been removed and replaced by a star shaped region 25 of substantially the same lateral extent. In addition, the surrounding segment-shaped illuminated regions 26 have been extended to form triangular light shapes with the apex of each triangle sitting on the periphery of the target region (identified in the Figure by the dotted line circle). Hence, the observer will be able to identify the location and approximate size of the target region on the target surface, although not to quite the same degree of precision achieved in the previous embodiment.

FIG. 7b shows an alternative mask 22 in which the pattern P of the illuminated regions takes the form of a logo, here a stylized letter “A”. The logo is made up of a central circular region 25 corresponding to the target region TR and hence forming a primary illumination region. Arranged around the circular region 25 are two secondary illumination regions 26 configured to form the letter “A” in combination with one another and the central region 25. The distinct shape of the circle 25 as compared with the other portions of the illuminated pattern assist the user in determining that it is this portion of the visible image which denotes the target region TR from which the temperature is being measured. To further assist in drawing the eye of the user towards this region, the edges of the adjacent secondary illumination regions 26 are curved to echo the shape of the central circular region 25, and the two sections of the “A” are spaced from one another at the top of the logo to form an apparent dark line intersecting the central region 25.

FIG. 7c shows another example of a mask 22 having a primary illumination region 25 and four secondary illumination regions 26, here in the form of arrows. In this example, the primary illumination region 25 is not circular but rather in the shape of a cross and this will be matched by the operative surface area of the thermal detector assembly, defined for example by the field stop aperture 17a. Thus, there is no limitation on the shape of the operative surface area nor that of the primary illumination region 25 and specialist applications may require particular target region shapes. However, by providing a primary illumination region which matches the operative surface area of the detector assembly, the target region TR can always be clearly identified by the user no matter what its shape.

FIG. 7d shows a further example of a mask 22 and, in this example, the primary illumination region 25 does not wholly fill the target region but defines its size and shape with an outline about its periphery, which here is annular. The outer edge of region 25 corresponds to the edge of the target region. To improve the size and visibility of the pattern, secondary illumination regions 26 forming additional concentric rings have been provided at higher radii.

Masks such as those described with reference to any of the embodiments above can be formed in a number of ways. In the simplest case, the translucent regions of the mask 22 may be formed by removing the corresponding shape(s) from a sheet of an opaque material such as metal or plastic. For example, the desired pattern can be machined, laser cut or etched out of a sheet of opaque material to leave apertures defining the desired pattern. This is a particularly robust implementation and therefore preferred in a large number of circumstances. However, this is less well suited to patterns exhibiting fine detail or isolated opaque regions, since once cut out of the sheet, such regions will have no support. Therefore, in alternative embodiments the mask 22 can be formed with a translucent material in place of apertures.

FIGS. 7e and 7f show two exemplary cross-sections of masks formed in this way. FIG. 7e is a cross-section of the mask shown in FIG. 7c and, here, the opaque regions 24 of the mask are formed integrally in a sheet material 22 which is inherently translucent. Thus, the regions 24 have been modified to increase their optical density relative to the unmodified regions 23 through which light will still be transmitted. The plate 22 can be formed, for example, of a photographic film which is sensitive to certain wavelengths, by exposing the film to the relevant wavelengths through a patterned mask, and then developing and fixing. Alternatively, the mask could be, for example, an LCD display having integral opaque and translucent regions as will be described further below. In FIG. 7f, the mask 22 is a multilayer structure having a translucent support layer 22a and an opaque masking layer 22b in which the pattern is formed. The support layer 22a could be, for example, a glass or polymer plate whilst the masking layer 22b could comprise a deposition of metallic or other opaque material of which portions are absent or removed to define the desired pattern P. For example, the pattern could be formed by demetalisation.

The configuration of the illuminated pattern P is preferably designed to assist the user in perceiving the projected visible light pattern, identifying the target region TR and determining whether the thermometer is in focus. By providing the pattern with secondary illumination regions 26 as described above, the overall size of the visible pattern I is greater than that of the target region TR itself which provides two major advantages. Firstly, the total illuminated surface area is increased, which increases the overall brightness of the feature, thereby rendering it more readily visible to the observer against a busy environmental background. Secondly, the increased overall area of the pattern makes it possible to introduce detailed pattern at a scale which can be discerned by the user, from some distance. Generally, the more detailed the pattern, the more sensitive the pattern will be to discrepancies in the focus of the instrument. That is, a highly detailed pattern will more quickly appear blurred and indistinct if the thermometer is out of focus by even a small amount, as compared with a less detailed pattern in which such blurring may be hard to distinguish. However, a balance needs to be maintained between total illuminated area of the pattern and the level of detail, since if the pattern is very finely detailed, e.g. through the use of thin line illuminations, the total amount of illuminated surface area will be small and hence the overall brightness and visibility reduced.

Thus, in preferred embodiments such as those illustrated above, the illuminated pattern P includes at least two translucent regions which will appear bright in the projected image, separated by a dark region. The at least two bright regions are preferably positioned sufficiently closely together such that if the image is out of focus, the blurred nature of their edges will be emphasised by the apparent merging of the two regions. For example, in particularly preferred embodiments, the adjacent bright regions may approach one another with a spacing of less than 1 mm, more preferably less than 0.1 mm. For example, in the mask shown in FIG. 7a, the overall pattern P may have a total diameter of approximately 1.6 mm and the spacing of the segments 26, labelled s, is around 0.08 mm. Likewise, in the example of FIG. 7b, the “A”-shaped logo has an average diameter (i.e. average of its height and width) of around 2 mm and the spacing s by which the various illuminated regions approach one another is around 0.1 mm.

The present Inventors have also found that improved results are obtained where the pattern includes a relatively large amount of “edge” between bright and dark regions across its area, corresponding to a high level of detail. Taking the sun-shape pattern shown in the mask of FIG. 5 as an example, here the illuminated pattern P has an overall diameter d of around 1.6 mm and the central circular region 25 has a diameter of around 0.25 mm (equal to that of the field stop aperture 17a). The peripheries of the illuminated regions 25, 26 (of which two are marked 29) have a total length of approximately 13.84 mm. The total surface area of the illuminated regions 25, 26 is approximately 1.38 mm². The ratio R of edge length to illuminated area, normalized by diameter is given by:

$$R = \frac{p}{a} \cdot d$$

### Where:

p=total perimeter of illuminated region(s) of illuminated pattern;
a=total area of illuminated region(s) of illuminated pattern; and
d=diameter of illuminated pattern.

Thus, in this example, R has a value of approximately 17. This should be compared with the corresponding ratio for a simple geometric shape such as an illuminated circle or square, which will have a value of R of around 4.

The Inventors have found that the patterns for which the ratio R has a value greater than 4, more preferably greater than 10 and still preferably greater than 15 are particularly effective. For example, the logo design shown in FIG. 7b has a value of R of approximately 16. Nonetheless, as mentioned above, too high a level of detail is not beneficial and thus maximum preferred values of R are considered to be approximately 50. In most preferred examples, the pattern will have a value of R lying in the range 15 to 25.

Tests have also shown that patterns incorporating one or more straight edges are particularly effective, since the observer can more readily determine when a straight edge is in focus as compared with curved features.

Preferably, the overall pattern is designed to draw the attention of the user to the location of the target region TR, and to this end it is preferred that the centre of the pattern P is arranged to approximately coincide with that of the target region TR in the focal plane FP. However, this is not essential since the pattern can be designed to direct the user to any other position in the pattern if desired (one example is given below with reference to FIG. 10). Nonetheless it has been found particularly effective if the pattern P is rotationally symmetric about the target region TR, although full rotational symmetry is not required. For example, the patterns shown in FIGS. 5, 6, and 7a have eightfold rotational symmetry, that in FIG. 7b has twofold rotational symmetry and that in FIG. 7c has fourfold rotational symmetry.

Any type of light emitting device can be used as the light source 21 provided it emits light over a suitably wide area so as to illuminate the desired pattern. For example, the light source 21 could comprise a defocused laser, an incandescent lamp or electroluminescent material. However, in most preferred embodiments, the light source 21 comprises a light emitting diode (LED). LEDs are particularly well suited to the application since they can be designed to emit light over a relatively large surface area rather than acting as a point source. For example, typical LED chips tend to have an illuminated area of at least 1 mm².

If desired, the light source 21 can comprise a plurality of LEDs or the like, to increase the overall illuminated area and/or to allow for enhanced effects such as multicoloured patterns or changeable patterns. For example, multiple light sources could be provided and controlled to switch on and off in sequence so as to illuminate different portions of the mask. This can be used to create the appearance of an animation or to convey data if the mask portions are shaped as numbers, letters or elements thereof. The primary and secondary illumination regions need not be illuminated at the same time, but this is preferred. Alternatively, different light sources could be illuminated in different modes of operation to display different parts of the pattern. If the visible light pattern is to be displayed in more than one colour, an appropriate set of light sources emitting at different wavelengths can be provided. For instance, it may be desirable to display the primarily illumination region in a different colour as compared with any secondary illumination regions, in order to clearly identify which illuminated region corresponds to the target region TR.

The light source(s) 21 is preferably operated at high power in order to increase the intensity and visibility of the illuminated light pattern on the target surface. For example, a minimum wattage of around 10 milliwatts is preferred since at lower powers the visible light pattern tends not to be sufficiently bright for easy observation. The only upper limit on the power is due to constraints on the available types of light source (for example, LEDs which can operate at more than 5 watts are rare) and also on the power source supplying the device. In general, it is preferred that the device receives power from a mains-type power source or generator, but in some embodiments, an onboard power source such as a battery or solar cell could be used.

The at least one light source 21 could be illuminated continuously during operation, or upon receipt of an “on” signal from the user (e.g. via an input such as a “trigger” style button. However, in preferred embodiments, the radiation thermometer further comprises a controller adapted to operate the at least one light source in a pulsed mode of operation, preferably at a pulse frequency of between 0.5 and 100 Hz, more preferably between 0.5 and 50 Hz. Pulsing the illumination of the light source(s) in this way can be used to avoid overheating of the light source. The pulsing may be so fast (e.g. about 30 Hz) that the illuminated pattern appears continuously illuminated to the human eye. However, in certain preferred implementations, the controller is adapted to pulse the light source at a pulse frequency which gives rise to visible flashing of the illuminated pattern, the pulse frequency preferably being between 0.5 and 30 Hz, more preferably between 2 and 10 Hz. This assists in drawing the attention of the user to the illuminated pattern and hence to the location of the target region.

The thermometer could be configured to apply such pulsing whenever in use. However, preferably the pulsed mode of operation and preferably the pulse frequency is selectable by the user, e.g. via a dial or other input means arranged on the thermometer, or via a controller to which the thermometer is connected. That is, the user can select whether the light source(s) are pulsed and, if so, the frequency. In practice, this may be implemented by enabling the user to select a pulse frequency within a range which includes frequencies at which the pattern will appear to flash (e.g. less than about 30 Hz) as well as higher frequencies at which the pattern will appear steady.

If desired, where more than one light source is provided, only selected ones of the light sources may be pulsed, with others being constantly illuminated.

The light emitted by the visible light source assembly 20 can be of any visible wavelength and, unless the light source is monochromatic, typically a range of visible wavelengths will be emitted. The wavelength(s) emitted by the light source assembly 20 should be different from the thermal wavelength(s) used by the detector assembly 15 to determine the temperature of the target body. In some cases, it is preferred that the waveband emitted by the light source assembly 20 has substantially no overlap with the waveband to which the thermal radiation detector assembly 15 is responsive. This avoids any distortion of the detector's output signal due to visible light arriving at the detector, e.g. caused by internal reflections within the thermometer body, hence preserving the accuracy of the measured temperature. However, this is not essential since the radiation splitter 30 or one or more additional filters (not shown) could instead be used to provide adequate shielding preventing any significant access to the detector by the visible light (or at least any wavelengths of the visible light which would interfere with those wavelengths to be detected by assembly 15).

In preferred examples, the colour of the visible light λ_{L} is selected so as to stand out clearly against the environment in which the thermometer is to be operated. For example, for typical industrial furnaces which glow red hot, the Inventors have found that the use of a green visible light pattern is particularly effective since the image is clearly visible to the user. Thus, in this example, the light emitting assembly 20 may emit a narrow waveband centred around the green portion of the visible spectrum, e.g. approximately 530 to 540 nm. For the same environment, typical temperatures are such that the thermometer is preferably operative in the infrared range and hence the thermal detector assembly is preferably responsive to an infrared waveband falling within the range 0.7 to 10 μm. The radiation splitter 30 is therefore configured to reflect visible wavelengths in the waveband emitted by the visible light assembly 20 (e.g. 530 to 540 nm) whilst transmitting the thermal radiation waveband in the infrared region to which the detector assembly 15 is responsive. Thus, the radiation splitter 30 could be implemented as a cold mirror, which is a thin film interference-type structure known in the art. Alternatively, the radiation splitter could be formed as a diffraction grating designed to diffract the visible light waveband away from the optic axis whilst transmitting the thermal radiation waveband.

In another example, where the thermometer is intended to be used in a very high temperature environment in which surfaces are glowing white hot, different wavebands for the visible light λ_{L} and thermal radiation λ_{T} may be preferred. For example, rather than detect infrared radiation, here the thermal radiation detector assembly 15 may detect the visible light radiated by the glowing objects, e.g. at a waveband around 500 nm. In this scenario, the present Inventors have found that a red visible light pattern is suitable, and avoids interference with the thermal radiation wavelengths to be detected, and hence the visible light assembly 20 may emit a waveband around 700 nm for example. Thus, in this example, the thermal radiation wavelength λ_{T} is shorter than the visible light wavelength λ_{L}, so if the geometry of the device is to be preserved, the radiation splitter 30 must be formed so as to transmit the shorter wavelength visible thermal radiation whilst reflecting the longer wavelength light from the illuminated pattern P. Thus, the radiation splitter 30 may be formed as a hot mirror, which again is a type of thin film interference structure known in the art. Again, an alternative is to use an appropriately configured diffraction grating as the radiation splitter 30.

It should be appreciated that the device geometry illustrated in FIG. 3 is merely one example of how the components might be arranged in order to achieve the required equal path length and combine the visible light and thermal radiation onto the same path through the focussing assembly 18. Alternative implementations will be discussed below.

FIGS. 8a and b depict a radiation thermometer 50 according to a second embodiment. FIG. 8a is a cross-section along the line A-A shown in FIG. 8b, which is an end view of the rear of the thermometer taken from the position of observer O. The thermometer components are contained within a housing 51 which may be provided with a water-cooled jacket (not shown) to insulate the device from the high temperature ambient surroundings. In use, the housing 51 will be mounted, e.g. via bracket 52, to a stand or wall or other surface for static monitoring of the required location. However, in other examples, the thermometer could be implemented as a hand-held or portable device. This is generally less preferred since, as mentioned previously, the high powered light source preferably receives power from a mains source or generator, rather than an onboard supply such as a battery. However, if a sufficiently high capacity onboard power supply is provided, hand-held versions are achievable.

As in the previous embodiment, a thermal radiation detection assembly 60 is configured to receive thermal radiation from a target body (not shown) through a focussing optics assembly 65. The cone marked λ in FIG. 8 illustrates the radiation path through the device onto the radiation detector assembly 60. The detector assembly 60 comprises a radiation detector 61 and a field stop 62 having an aperture therethrough which defines the operative surface area of the detector assembly 60 as before.

In this example, the focusing optics assembly 65 is implemented as a curved mirror system, specifically a cassegrain mirror system. The key components of the focussing optics assembly 65 are shown in isolation in FIG. 9. The assembly comprises two curved mirrors 66 and 67 spaced from one another along the optic axis. Mirror 66 is termed the back mirror and receives incoming thermal radiation λ_{T} through an annular region surrounding front mirror 67. The back mirror 66 includes an annular curved section which reflects incoming radiation onto the back surface of front mirror 67 which itself is dome shaped. Front mirror 67 thus reflects the incident radiation back into the thermometer through a central aperture in the back mirror 66. The curvature of the two mirrors is configured to achieve focussing of the incoming radiation as shown in FIG. 9 such that the radiation is focussed onto detector assembly 60 in a manner equivalent to the result of a lens system.

The use of a mirror-based focussing system such as this is preferred since the mirrored surfaces are largely achromatic, thereby applying the same focussing power to both the incoming thermal radiation wavelength and the outgoing visible light. The visible light rays are not shown in FIG. 9, but will follow the same path as the thermal radiation through the cassegrain system.

To adjust the position at which the image of the radiation detector assembly 60 will be formed in front of the thermometer (i.e. the focal plane), the two mirror components 66 and 67 can be moved along the optical axis relative to one another. For example, in preferred embodiments, the focus is adjusted by moving back mirror 66 towards or away from the front mirror 67, which preferably remains in a fixed position.

Returning to FIG. 8, a visible light source assembly 70 is positioned away from the optic axis as in the first embodiment, and comprises a light source 71 and patterned mask 72. The light source assembly 70 is positioned to project the illuminated light pattern P onto a radiation splitter 80 positioned in the thermal radiation path between the thermal radiation detector assembly 60 and focussing optics assembly 65. As in the previous embodiment, the radiation splitter may be, for example, a cold or hot mirror depending on the wavelengths in use. The radiation splitter 80 combines the visible light onto the same path through the focussing optics assembly 65 as the thermal radiation such that a focussed image of the illuminated light pattern is formed in the same focal plane FP as the target region defined by the image of the operative area of the radiation detector assembly 60, in the same manner as described above.

In this embodiment, the thermometer body also houses a processor 85, such as a microprocessor, which is adapted to receive the output signal from thermal radiation detector 61 and compute the radiance and/or temperature of the target region from the signal using techniques well-known in the art. The thermometer is provided with a display, such as a LCD monitor 86, at the rear of the device to which the calculated radiance and/or temperature is output for display to the user. In other embodiments, the computed radiance and/or temperature could be output using other means, e.g. transmitted (wirelessly or otherwise) to an external device such as a computer. In still further embodiments, the processor 85 may not itself carry out the computations necessary to determine radiance and/or temperature. Rather, the raw signal from the detector 61 could be output directly to an external device where the computation will be carried out.

To ascertain the overall field of view of the thermometer, the device could be equipped with a sight, such as a telescopic sight, through which the user can view the approximate scene visible to the thermometer. However, in the present embodiment, this is achieved by equipping the thermometer with a visible light camera 90 which could comprise, for example, a CCD array. Such cameras can be made sufficiently small so as to be located on the front surface of the thermometer without obstructing the thermometer's receipt of thermal radiation (or projection of visible light). For example, in the present embodiment, the camera 90 is located in front of the front mirror 60 of the cassegrain system. This essentially is unused volume and thus the presence of the camera 90 will not obstruct the passage of radiation through the cassegrain system.

The signal from camera 90 is preferably supplied to an onboard display 91 (which in this example is combined with monitor 86) so that the user can observe the field of view of the device and achieve coarse alignment quickly. However, in other examples, the signal output could be transmitted (wirelessly or otherwise) to an external device such as a computer.

The illuminated pattern used in the FIG. 8 embodiment can take any of the forms discussed in relation to the first embodiment. For example, the mask defining the pattern may be as shown in FIG. 5 or any of FIGS. 7a to 7f. However, as mentioned previously, one option for forming the mask which provides additional benefits is to make use of a liquid crystal display (LCD). An example of a mask incorporating an LCD will now be described with reference to FIG. 10.

FIG. 10 shows a mask 100 comprising an opaque plate 101 formed, for example, of a metal or plastic sheet having translucent regions 102, 103 defined therein using any of the same techniques previously discussed. For example, each translucent region 102, 103 could be a cut-out through the opaque plate 101. In this example, one of the translucent regions is a primary illumination region 102 whose shape and position are such that the image of the illuminated region in the focal plane will coincide with the target region from which thermal radiation will be collected by the thermometer. Thus, the circular spot 102 defines the measurement position. Three secondary illumination regions labelled 103 are provided around the primary illumination region 102 and here they take the form of triangles with their apexes arranged to direct the user's eye towards the primary illumination region. As explained above, the inclusion of the secondary illumination regions increases the overall size and brightness of the displayed pattern, hence improving its visibility to the user and assisting the user in determining when the pattern is in focus on the target surface.

The mask 100 also includes a further secondary illumination region formed by LCD 105. The LCD 105 is mounted in an aperture provided in plate 101, the extent of which is indicated by the dashed line rectangle. The LCD 105 comprises crossed polar filters with a layer of liquid crystal polymer sandwiched between them and shaped electrode plates, as is known in the art. Power is supplied to selected electrodes via a contact 106 which is in communication with the thermometer's processor 85. In the example shown, the electrodes are shaped so as to make up a digital display of letters and/or numbers. The activation of each individual electrode leads to a modification in the liquid crystal layer which renders the LCD substantially opaque in the locality of the electrode. In other regions, where there is no electrode or where an existing electrode is not activated, the liquid crystal display is translucent. Hence, in the focussed image of the mask 100, the LCD 105 will appear as a backlit display, i.e. a bright rectangle with dark digital numbers overlaid thereon. Here, the display is depicted as showing the number “688.9”, which could be representative of a temperature measurement made by the thermometer. Any other data or message could be displayed instead under the control of the processor, as will be discussed further below.

In this example, the LCD 105 makes up only a portion of the mask 100. However, in other examples, the entire mask could be constituted by an LCD and any primary or secondary illumination regions provided could be defined using appropriately shaped LCD electrodes.

The use of an LCD display as all or part of the mask allows the displayed pattern to be changed under the control of the processor. This can be used in a number of ways. One example, the processor could store a plurality of different patterns in memory for selection either by the user or by the processor. For example, particular patterns may prove more effective in certain environments than others and the user could select the pattern found to be most clearly visible for each given circumstance. Typically, some form of input module such as a keypad will be provided on the device to enable such user input. Alternatively, the decision as to which pattern to display could be made by the processor. For example, it may be found that one pattern is most effective when the thermometer is focussed at relatively close distances, whereas another is more effective at greater distances. Thus, the processor 85 could select the most appropriate pattern for display on the LCD based on the known focus position of the optics assembly 65.

In a still further example, the LCD could be updated dynamically during display to the user. For instance, in the example given above, the temperature output from the processor 85 may be updated in real time, in which case, the displayed pattern will also change. In other examples, the pattern may appear to be animated by controlling different parts of the LCD to become opaque and translucent in a controlled sequence. This could be used to assist in drawing the eye of the user towards the location of the target region. For example, a series of secondary illumination regions outside the target region could be made translucent in sequence such that, in the visible image, the bright portions appear to move towards the target region. However, it is generally preferred that any such animation is sufficiently slow that the user has sufficient time to determine that the pattern is indeed correctly focussed on the target surface.

In each of the above examples, the thermal radiation detector assembly 20 is arranged on the optic axis O-O′ of the focussing assembly 18 whilst the visible light source assembly is arranged off-axis. However, this arrangement can be reversed and FIG. 11 depicts a third embodiment of a radiation thermometer in which this is the case. Here, each of the components already described with reference to FIG. 3 are labelled using the same reference numbers. Thus, the visible light source assembly 20 is arranged on the optic axis of the focussing assembly 18, whilst the thermal radiation detector 15 is positioned off-axis. In order that visible light will reach the focussing system, the radiation splitter 30 must, in this embodiment, be configured to transmit the visible light waveband λ_{L} emitted by the light source 21 and to reflect the thermal radiation waveband λ_{T} to which the thermal radiation detector is assembly 15 is responsive. For instance, if the thermometer is to operate at infrared wavelengths and emit a green visible light pattern, the radiation splitter 30 may be implemented as a hot mirror. Alternatively, if the thermal radiation detector assembly is to be responsive to visible light, e.g. 500 nm, and a red visible light pattern is to be projected, a cold mirror might be used instead.

As already mentioned, mirror-based implementations of the focussing optics assembly 18 are preferred. However, an assembly of one or more lenses can be used instead, provided the lens materials are carefully selected. Nonetheless, lens systems will tend to focus different wavelengths to slightly different positions, due to the focussing mechanism being based on refraction which is wavelength dependent. To account for this, in certain embodiments, one or more compensation elements may be used to adjust the focus of one or other (or both) of the wavelengths in use. An example of such compensation element is shown in FIG. 11 as lens 19. Here, lens 19 is positioned in the optical path between the thermal radiation detector assembly 15 and the radiation splitter 30 such that it does not interfere with the visible light passing through the system. Thus, compensation element 19 applied a small amount of additional focus (or defocus) to the thermal radiation in order that the focussing assembly 18 will focus both the image of the operative surface area of the detector (i.e. the target region TR) and the visible light pattern in the same focal plane FP. Of course, in other examples, the compensation element 19 might be inserted into the light path between the radiation splitter 30 and the visible light source assembly 20 instead, or one or more such elements 19 might be inserted into both paths.

It should further be appreciated that whilst in the embodiments depicted so far the radiation splitter 30 is positioned at approximately 45° to the optic axis O-O′ such that the reflected light path L₂ (or L₃ in the FIG. 3 embodiment) is approximately orthogonal to the optic axis, this is not essential. Rather, the radiation splitter 30 can be positioned in any orientation which reflects one of the wavelengths in use between the optic axis and an off-axis position, and the off-axis assembly (either the radiation detector assembly or the visible light emitting assembly) will be positioned accordingly. For instance, if the radiation splitter 30 in FIG. 3 or FIG. 11 is rotated towards a vertical position, the reflected radiation will form an obtuse angle with that transmitted. Thus, the off-axis component (either the thermal radiation detector assembly 15 or the visible light source assembly 20 can be located closer to the optical axis, reducing the overall size of the instrument.

FIG. 12 depicts a further embodiment with an even more compact arrangement of the components. Here, the radiation splitter 30 is configured as a diffraction grating which transmits both wavelengths λ_{T} and λ_{L}, but diffracts them differently. In this case, the direction of diffraction is different whilst the angle of diffraction is approximately the same, whereas in other cases, the direction may be the same but the angle different (or a combination of the two). Thus, the angle θ subtended at the radiation splitter 30 between the thermal radiation detector assembly 15 and the visible light source assembly 20 is determined by the degree of diffraction of each wavelength, and is preferably 90 degrees or less. Both of the assemblies 15 and 20 are thus offset from the optical axis and so can be arranged to reduce the overall size of the instrument (in the direction orthogonal to the optical axis O-O′). Preferably, the angle θ is made as small as possible whilst still ensuring adequate separation between the two wavelengths, in order that the two assemblies 15, 20 can be more closely positioned. For example, in particularly preferred embodiments, the angle θ is no greater than 30 degrees.

FIG. 13 is a block diagram showing key functional modules of the radiation thermometer in one embodiment and the interactions between them. The functional components are identified using the same reference numerals as used with respect to FIG. 8. Thus, radiation detector assembly 60 outputs a signal in response to detected thermal radiation to processor 85. As discussed above, this is preferably output to the user via a monitor or other output means 86. The processor 85 may also control the visible light source assembly 70. This may be simply in terms of switching the visible light sources on or off when the thermometer is switched on, or could involve more complex control commands if, for example, the assembly includes an LCD display or multiple light sources. The processor 85 may also include a controller for pulsed operation of the light source(s) as discussed above. In alternative embodiments, the visible light source assembly 70 may not be under the control of processor 85 and may simply receive power directly from power source 99 when the instrument is switched on. If the pattern being displayed by the light source assembly 70 is changeable, the processor 85 may include a memory 89 for storing one or more patterns or animation sequences to be output by the assembly. Alternatively, as mentioned above, the processor 85 could output a calculated radiance or temperature value based on the signal from detector 60 to the assembly 70 for projection as part of the illuminated pattern.

As shown in the FIG. 8 embodiment, the radiation thermometer preferably includes a visible light camera 90 and corresponding monitor 91. The signal from the camera 90 may be processed by the same processor 85 for output to the monitor 91 or the signal may be diverted directly from camera 90 to monitor 91.

1. A radiation thermometer comprising:
a thermal radiation detector assembly having an operative surface area responsive to thermal radiation of a first wavelength;
a focussing optics assembly adapted to focus both thermal radiation of the first wavelength and visible light of a second wavelength along an optical axis, the focussing optics assembly being configured to form a focussed image of the operative surface area of the thermal radiation detector assembly on a focal plane outside the radiation thermometer, the focussed image of the operative surface area defining a target region from which the thermal radiation detector assembly detects thermal radiation;
a visible light source assembly adapted to exhibit an illuminated pattern of visible light of the second wavelength, the visible light source assembly comprising at least one visible light source and a mask through which light from the at least one visible light source is arranged to pass, the mask having one or more substantially opaque portions and one or more translucent portions arranged to define the illuminated pattern; and
a radiation splitter adapted to deflect one of thermal radiation of the first wavelength and visible light of the second wavelength, and to transmit the other, or to deflect both wavelengths differently, the radiation splitter being configured so as to pass the thermal radiation along a first optical path from the focussing optics assembly to the thermal radiation detector assembly, and to pass the visible light along a second optical path from the visible light source assembly to the focussing optics assembly;
wherein the length of the first optical path is substantially equal to that of the second optical path, such that the focussing optics additionally forms a focussed image of the illuminated pattern of the visible light source assembly substantially on the focal plane, the illuminated pattern being configured to mark the location of the target region in the focal plane; and
wherein the illuminated pattern includes a primary illumination region and at least one secondary illumination region, the primary illumination region having substantially the same lateral extent as the operative surface area of the thermal radiation detector assembly and being positioned such that the image of the primary illumination region formed at the focal plane falls substantially within and is substantially co-incident with the target region from which the thermal radiation detector assembly detects thermal radiation, and the at least one secondary illumination region being configured such that the image of the or each secondary illumination region formed at the focal plane is located outside the target region.

2. A radiation thermometer according to claim 1 wherein the mask comprises either:
a sheet of substantially opaque material having one or more aperture(s) therethrough forming the one or more translucent portions; or
a sheet of translucent, preferably transparent, material of which one or more portions are opacified, thereby forming the one or more substantially opaque portions.

3. (canceled)

4. (canceled)

5. (canceled)

6. (canceled)

7. A radiation thermometer according to claim 1, wherein the or each visible light source comprises a light emitting diode, defocused laser, incandescent lamp or an electroluminescent material.

8. (canceled)

9. (canceled)

10. A radiation thermometer according to claim 1, further comprising a controller adapted to operate the at least one light source in a pulsed mode of operation, preferably at a pulse frequency of between 0.5 and 100 Hz, more preferably between 0.5 and 50 Hz.

11. A radiation thermometer according to claim 10, wherein the controller is adapted to pulse the light source at a pulse frequency which gives rise to visible flashing of the illuminated pattern, the pulse frequency preferably being between 0.5 and 30 Hz, more preferably between 2 and 10 Hz.

12. A radiation thermometer according to claim 10, wherein the pulsed mode of operation and preferably the pulse frequency is selectable by the user.

13. A radiation thermometer according to claim 1, wherein the primary illumination region is of substantially the same shape and size as the operative surface area of the thermal radiation detector assembly and being positioned such that the image of the primary illumination region formed at the focal plane is substantially co-incident with and substantially fills the target region from which the thermal radiation detector assembly detects thermal radiation.

14. A radiation thermometer according to claim 1, wherein the at least one secondary illumination region identifies at least a point of the periphery of the target region.

15. A radiation thermometer according to claim 1, wherein the illuminated pattern includes a plurality of secondary illumination regions configured such that the target region is located between images of the secondary illumination regions in the focal plane.

16. A radiation thermometer according to claim 15, wherein the secondary illumination regions are configured such that the images of the secondary illumination regions are rotationally symmetrical around the target region in the focal plane.

17. (canceled)

18. A radiation thermometer according to claim 1, wherein the illuminated pattern includes at least two illuminated regions separated from one another by a non-illuminated region, the at least two illuminated regions preferably being spaced on the mask at at least one point by no more than 1 mm, preferably no more than 0.5 mm, more preferably no more than 0.1 mm, still preferably no more than 0.05 mm.

19. A radiation thermometer according to claim 1, wherein the illuminated pattern comprises at least one, preferably a plurality of, straight edges between illuminated and non-illuminated regions.

20. A radiation thermometer according to claim 1, wherein the ratio R has a value greater than 4, preferably greater than or equal to 10, more preferably greater than or equal to 15, and preferably less than or equal to 50, more preferably less than or equal to 25, most preferably in the range 15 to 25, where R is defined as:
$$R = \frac{p}{a} \cdot d$$
Where:
p=total perimeter of illuminated region(s) of illuminated pattern;
a=total area of illuminated region(s) of illuminated pattern; and
d=diameter of illuminated pattern.

21. (canceled)

22. A radiation thermometer according to claim 1, wherein the thermal radiation detector assembly comprises at least one thermal radiation detector responsive to thermal radiation of the first wavelength and a field stop disposed between the at least one thermal radiation detector and the radiation splitter, the field stop defining the operative surface area of the thermal radiation detector assembly, and the first optical path being defined between the field stop and the focussing optics assembly.

23. (canceled)

24. (canceled)

25. (canceled)

26. (canceled)

27. (canceled)

28. (canceled)

29. (canceled)

30. (canceled)

31. (canceled)

32. A radiation thermometer according to claim 1, wherein the length of the first and second optical paths is adjustable to thereby adjust the position of the focal plane relative to the focussing optics system along the optical axis.

33. A radiation thermometer according to claim 1, wherein the thermal radiation detector assembly, the visible light source assembly and radiation splitter are fixed in relation to one another, forming a unit which is movable relative to at least a part of the focussing optics system to enable the length of the first and second optical paths to be adjusted.

34. A radiation thermometer according to claim 1, further comprising a processor adapted to receive a signal output by the thermal radiation detector assembly representative of the thermal radiation detected, and to compute the radiance and/or the temperature of the target region from the signal.

35. (canceled)

36. (canceled)

37. (canceled)

38. A radiation thermometer according to claim 1, further comprising a visible light camera configured to have a field of view including the target region, and a monitor for display of the image received by the visible light camera.

39. (canceled)

40. (canceled)

41. A method of identifying the target region of a radiation thermometer according to claim 1, comprising directing the radiation thermometer towards an object, the temperature of which is to be measured, and activating the at least one light source such that the object is illuminated by the illuminated pattern, whereby the location of the target region is identified by the primary illumination region.

42. A method according to claim 41 further comprising adjusting the distance between the radiation thermometer and the object and/or adjusting the focal power of the radiation thermometer such that a surface of the object is substantially coincident with the focal plane of the radiation thermometer.

43. A method according to claim 41, further comprising pulsing the activation of the at least one light source preferably at a pulse frequency of between 0.5 and 100 Hz, more preferably between 0.5 and 50 Hz.

44. A method according to claim 43, wherein the light source is pulsed at a pulse frequency which gives rise to visible flashing of the illuminated pattern, the pulse frequency preferably being between 0.5 and 30 Hz, more preferably between 2 and 10 Hz.
